(19) United States
(12) Patent Application Publication
(10) Pub. No.: US 2021/0365936 A1
(43) Pub. Date: Nov. 25, 2021

(54) CONTROL METHOD, SERVER, AND RECORDING MEDIUM

(71) Applicant: Panasonic Intellectual Property Corporation of America, Torrance, CA (US)

(72) Inventors: Yuji UNAGAMI, Osaka (JP); Junji MICHIYAMA, Fukuoka (JP); Yuuki HIROSE, Osaka (JP); Tetsuji FUCHIKAMI, Osaka (JP); Motoji OHMORI, Osaka (JP)

(21) Appl. No.: 17/392,687

(22) Filed: Aug. 3, 2021

Related U.S. Application Data
(63) Continuation of application No. PCT/JP2020/004453, filed on Feb. 6, 2020.
(60) Provisional application No. 62/802,856, filed on Feb. 8, 2019.

(51) Int. Cl. G06Q 20/38; G06Q 40/04; G06Q 20/42; G06F 16/23

(52) U.S. Cl. CPC G06Q 20/389; G06F 16/2379; G06Q 20/42; G06Q 40/04

(57) ABSTRACT

A control method includes: receiving application information including a scheduled date and time of a transaction, from a terminal; calculating, with reference to a distributed ledger, a fee based on a transaction by a first user recorded in the distributed ledger before the scheduled date and time included in the application information; transmitting fee information including the fee, to the terminal; receiving first transaction data including a first token quantity for the transaction, transferring the first transaction data to a plurality of other servers different from a server from among a plurality of servers, and storing a first block including the first transaction data in the distributed ledger; and receiving second transaction data including a second token quantity for the fee, transferring the second transaction data to the plurality of other servers, and storing a second block including the second transaction data in the distributed ledger.

### CROSS REFERENCE TO RELATED APPLICATIONS

This is a continuation application of PCT International Application No. PCT/JP2020/004453 filed on Feb. 6, 2020, designating the United States of America, which is based on and claims priority of U.S. Provisional Patent Application No. 62/802,856 filed on Feb. 8, 2019. The entire disclosures of the above-identified applications, including the specifications, drawings and claims are incorporated herein by reference in their entirety.

### FIELD

The present disclosure relates to a control method, a server, and a recording medium.

### BACKGROUND

PTL 1 discloses a mechanism in which, to encourage users to consume virtual currency instead of holding the virtual currency as an investment, purchased virtual currency depreciates over time from the time of purchase.

### CITATION LIST

### Patent Literature

PTL 1: Japanese Unexamined Patent Application Publication No. 2016-170530

### SUMMARY

### Technical Problem

However, there is possibility that processing of a plurality of servers for managing transactions of tokens such as virtual currency becomes unstable.

In view of this, the present disclosure provides a control method, etc. that can stabilize processing of each server for managing token transactions.

### Solution to Problem

A control method according to an aspect of the present disclosure is a control method executed by a server from among a plurality of servers that manage transactions of a token using a plurality of distributed ledgers and each manage one or more distributed ledgers from among the plurality of distributed ledgers, the control method including: receiving application information including a scheduled date and time of a transaction by a first user, from a terminal operated by the first user; calculating, with reference to a first distributed ledger managed by the server, a fee based on a transaction by the first user recorded in the first distributed ledger before the scheduled date and time included in the application information received; transmitting fee information including the fee calculated, to the terminal; receiving, from the terminal, first transaction data including a first token quantity indicating a quantity of the token for the transaction scheduled, transferring the first transaction data received to a plurality of other servers different from the server from among the plurality of servers, and storing a first block including the first transaction data in the first distributed ledger; and receiving, from the terminal, second transaction data including a second token quantity indicating a quantity of the token for the fee, transferring the second transaction data received to the plurality of other servers, and storing a second block including the second transaction data in the first distributed ledger.

These general and specific aspects may be implemented using a system, a device, an integrated circuit, a computer program, or a computer-readable recording medium such as CD-ROM, or any combination of systems, devices, integrated circuits, computer programs, and recording media.

### Advantageous Effects

The control method according to an aspect of the present disclosure can stabilize processing of each server for managing token transactions.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram schematically illustrating a structure of a transaction management system in an embodiment.

FIG. 2 is a block diagram schematically illustrating a structure of a server in the embodiment.

FIG. 3 is an explanatory diagram illustrating an example of fee calculation information in the embodiment.

FIG. 4 is an explanatory diagram schematically illustrating application transaction data in the embodiment.

FIG. 5 is an explanatory diagram schematically illustrating payment transaction data in the embodiment.

FIG. 6 is an explanatory diagram schematically illustrating fee transaction data in the embodiment.

FIG. 7 is a flowchart illustrating an example of processing in the transaction management system in the embodiment.

FIG. 8 is a diagram illustrating an example of a UI displayed by a display in a terminal.

FIG. 9 is a diagram illustrating an example of a UI displayed by the display in the terminal.

FIG. 10 is a diagram illustrating an example of a UI displayed by the display in the terminal.

FIG. 11 is a diagram illustrating an example of a UI displayed by the display in the terminal.

FIG. 12 is a block diagram schematically illustrating a structure of a transaction management system in Variation 3 of the embodiment.

FIG. 13 is a block diagram schematically illustrating a structure of a transaction management system in Variation 3.

FIG. 14 is a flowchart illustrating processing in a server in Variation 4 of the embodiment.

FIG. 15 is a block diagram schematically illustrating a structure of the server in Variation 4.

FIG. 16 is an explanatory diagram illustrating a data structure of a blockchain.

FIG. 17 is an explanatory diagram illustrating a data structure of transaction data.

### DESCRIPTION OF EMBODIMENT

### Underlying Knowledge Forming Basis of the Present Disclosure

In relation to the token transaction-related technique described in the Background section, the inventors have found the following problem:

With the mechanism described in PTL 1, the amount of depreciation of a token such as virtual currency with time is predetermined, so that it is difficult to control transactions depending on the situations of the transactions. For example, in the case where many transactions are concentrated in a certain period, there is possibility that the processing loads of a plurality of servers that mange the token increase and the processing by the plurality of servers becomes unstable. For example, there is also possibility that, in another period, no transaction occurs and the plurality of servers do not perform transaction-related processing. In such a case, the plurality of servers wait for a transaction to occur. Thus, power may be consumed despite no transaction-related processing being performed.

In view of this, the present disclosure provides a control method, etc. that can stabilize processing of a plurality of servers for managing token transactions and also save power consumed without transaction-related processing being performed, by controlling the timings of occurrence of transactions so that the processing of the plurality of servers will not be concentrated in a specific period.

A control method according to an exemplary embodiment disclosed herein is a control method executed by a server from among a plurality of servers that manage transactions of a token using a plurality of distributed ledgers and each manage one or more distributed ledgers from among the plurality of distributed ledgers, the control method including: receiving application information including a scheduled date and time of a transaction by a first user, from a terminal operated by the first user; calculating, with reference to a first distributed ledger managed by the server, a fee based on a transaction by the first user recorded in the first distributed ledger before the scheduled date and time included in the application information received; transmitting fee information including the fee calculated, to the terminal; receiving, from the terminal, first transaction data including a first token quantity indicating a quantity of the token for the transaction scheduled, transferring the first transaction data received to a plurality of other servers different from the server from among the plurality of servers, and storing a first block including the first transaction data in the first distributed ledger; and receiving, from the terminal, second transaction data including a second token quantity indicating a quantity of the token for the fee, transferring the second transaction data received to the plurality of other servers, and storing a second block including the second transaction data in the first distributed ledger.

In this way, the timings of occurrence of transactions can be controlled so that the processing of the plurality of servers for managing token transactions will not be concentrated in a specific period. Thus, the processing of the plurality of servers can be stabilized, and power consumed without transaction-related processing being performed can be saved.

For example, the application information may be third transaction data including the scheduled date and time, the plurality of distributed ledgers may each include contract code for calculating the fee based on the third transaction data, and the calculating may include calculating the fee by executing the contract code included in the first distributed ledger, when the third transaction data is received.

In this way, the fee can be calculated promptly and safely without involving any other person or system. Thus, the power consumption of the plurality of servers that manage token transactions can be reduced.

For example, the storing of the first block may include executing a consensus algorithm together with the plurality of other servers and storing the first block in the first distributed ledger, and the storing of the second block may include executing the consensus algorithm together with the plurality of other servers and storing the second block in the first distributed ledger.

In this way, the distributed ledger is stored as a result of the execution of the consensus algorithm. The execution of the consensus algorithm can thus facilitate appropriate management of token transactions.

For example, the calculating may include calculating the fee to increase with an increase in a balance of the token of the first user in the first distributed ledger.

In this way, the first user can be encouraged to use the token early. The timings of occurrence of transactions can thus be controlled.

For example, the calculating may include calculating the fee to increase with an increase in an elapsed time from a timing of a last transaction by the first user in the first distributed ledger.

In this way, the first user can be encouraged to use the token early. The timings of occurrence of transactions can thus be controlled.

For example, the calculating may include calculating the fee to increase with a decrease in an average of a transaction volume per unit time of transactions by the first user in the first distributed ledger within a predetermined period up to a current time.

In this way, the first user can be encouraged to use the token early. The timings of occurrence of transactions can thus be controlled.

For example, the fee information may be information for displaying the fee on a display of the terminal.

In this way, the fee is displayed on the display of the terminal, so that the first user can be encouraged to use the token early. The timings of occurrence of transactions can thus be controlled.

For example, the token may include a plurality of types of tokens, the first distributed ledger may include a plurality of different sub-distributed ledgers each for a different one of the plurality of types of tokens, the calculating may include calculating a plurality of fees each for the different one of the plurality of types of tokens, based on a transaction by the first user recorded in the plurality of different sub-distributed ledgers before the scheduled date and time included in the application information, and the transmitting may include transmitting, as the fee information, information including the plurality of fees calculated, to the terminal.

In this way, the fee is calculated for each of the plurality of types of tokens, so that the transaction volume can be adjusted for each type of token.

For example, the fee information may be information for displaying each of the plurality of fees for the different one of the plurality of types of tokens, on a display of the terminal.

In this way, the fee is displayed on the display of the terminal for each type of token, so that the first user can be encouraged to use the token early according to the type. The timings of occurrence of transactions can thus be controlled for each type of token.

For example, the fee information may include inquiry information for inquiring of the first user whether to agree to the fee included in the fee information.

In this way, whether to agree to the fee can be inquired of the first user via the terminal. Hence, the timing of the first user using the token can be adjusted. For example, the timing of using the token can be made earlier when the amount of the fee is larger. The timings of occurrence of transactions can thus be controlled.

A server according to an exemplary embodiment disclosed herein is a server from among a plurality of servers that manage transactions of a token using a plurality of distributed ledgers and each manage one or more distributed ledgers from among the plurality of distributed ledgers, the server including: a manager that manages a first distributed ledger from among the plurality of distributed ledgers; a receiver that receives, from a terminal operated by a first user, application information including a scheduled date and time of a transaction by the first user, first transaction data including a first token quantity indicating a quantity of the token for the transaction scheduled, and second transaction data including a second token quantity indicating a quantity of the token for a fee; a calculator that calculates, with reference to the first distributed ledger in the manager, the fee based on a transaction by the first user recorded in the first distributed ledger before the scheduled date and time included in the application information received; and a transmitter that transmits fee information including the fee calculated, to the terminal, wherein when the receiver receives the first transaction data, the transmitter transfers the first transaction data received to a plurality of other servers different from the server from among the plurality of servers, and the manager records a first block including the first transaction data in the first distributed ledger, and when the receiver receives the second transaction data, the transmitter transfers the second transaction data received to the plurality of other servers, and the manager records a second block including the second transaction data in the first distributed ledger.

With this, the timings of occurrence of transactions can be controlled so that the processing of the plurality of servers for managing token transactions will not be concentrated in a specific period. Thus, the processing of the plurality of servers can be stabilized, and power consumed without transaction-related processing being performed can be saved.

A recording medium according to an exemplary embodiment disclosed herein is a non-transitory computer-readable recording medium having a program recorded thereon for causing a computer to execute the above-described control method.

With this, the same effects as the control method described above can be achieved.

These general and specific aspects may be implemented using a system, a device, an integrated circuit, a computer program, or a computer-readable recording medium such as CD-ROM, or any combination of systems, devices, integrated circuits, computer programs, and recording media.

An embodiment will be described in detail below, with reference to the drawings.

The embodiment described below shows a general and specific example. The numerical values, shapes, materials, structural elements, the arrangement and connection of the structural elements, steps, the order of steps, etc. shown in the following embodiments are mere examples, and do not limit the scope of the present invention. Of the structural elements in the embodiments described below, the structural elements not recited in any one of the independent claims representing the broadest concepts are described as optional structural elements.

### Embodiment

This embodiment describes a transaction management system, a control method therefor, and the like that can stabilize processing by a plurality of servers in a token transaction management system and reduce unnecessary power consumption.

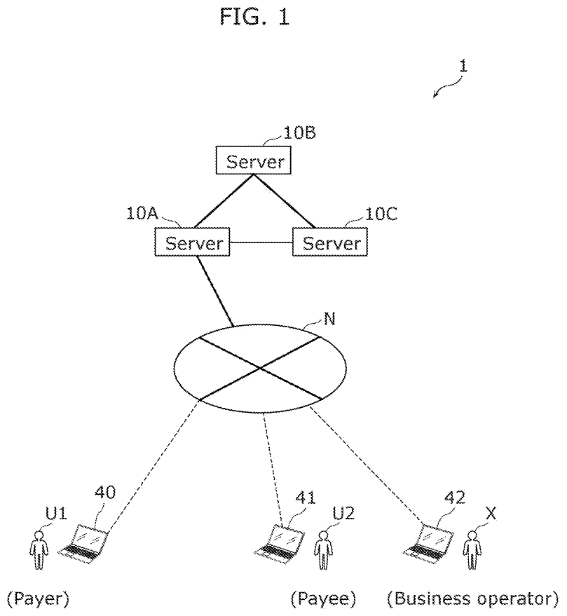

FIG. 1 is a block diagram schematically illustrating a structure of transaction management system 1 in this embodiment.

As illustrated in FIG. 1, transaction management system 1 includes servers 10A, 10B, and 10C and terminals 40, 41, and 42. The devices included in transaction management system 1 are communicably connected to one another via network N. Network N may be any communication line or network. Examples include the Internet and a mobile phone carrier network. Servers 10A, 10B, and 10C are also referred to as “server 10A, etc.” or “server 10A or the like”.

The plurality of servers 10A, 10B, and 10C manage token transactions using a plurality of distributed ledgers. Server 10A is one of the plurality of servers 10A, 10B, and 10C. Server 10A is one of the plurality of servers 10A, 10B, and 10C that each have a distributed ledger. The distributed ledger in server 10A is used to store various transaction data relating to procedures or processing (application, payment, fee payment, etc.) in transactions of transaction currency. Server 10A receives such transaction data to accept a procedure or processing in a token transaction. The token is value information managed by a distributed ledger, and corresponds to or is exchangeable with money, points (royalty), a gift certificate, a coupon, or the like.

Each of servers 10B and 10C is a device having the same functions as server 10A, and operates independently of server 10A. The number of servers is not limited to three, as long as the number is two or more. Server 10A, etc. are communicably connected to one another. Server 10A, etc. may be connected to one another via network N.

Although an example in which server 10A from among server 10A, etc. receives transaction data from terminal 40, etc. and transmits a notification to terminal 40, etc. is described here, any other server (server 10B or 10C) may perform such processing.

Terminal 40 is a terminal device of payer U1. Terminal 40 is a terminal for performing token transaction application, token transaction, and fee payment to server 10A, etc. For example, terminal 40 receives input indicating the scheduled date and time of a token transaction and input indicating the estimated transaction amount, from payer U1. Terminal 40 generates transaction data (also referred to as application transaction data or third transaction data) for transaction application based on the received input, and transmits the generated application transaction data to server 10A, etc. Specifically, terminal 40 generates transaction data including the scheduled transaction date and time and the estimated transaction amount, as the application transaction data. The application transaction data may not include the scheduled transaction date and time and the estimated transaction amount, as long as it includes information indicating the transaction schedule.

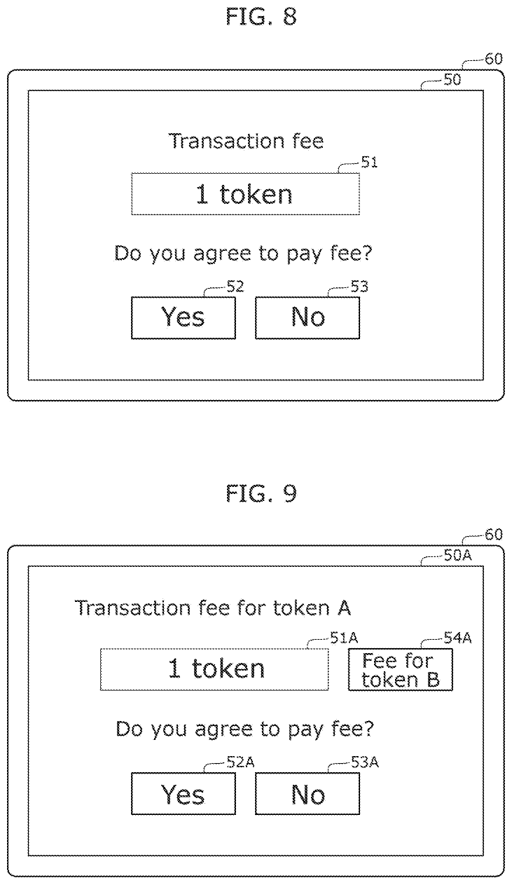

Terminal 40 may receive fee information from server 10A, etc., and display the received fee information. The fee information is information for displaying the fee on display 60 (see FIG. 8) in terminal 40. Terminal 40 generates, based on the received fee information, transaction data (also referred to as fee transaction data or second transaction data) for paying the fee to business operator X that manages the procedure of the transaction, and transmits the generated transaction data to server 10A, etc. Specifically, terminal 40 generates transaction data including the amount of the fee included in the fee information, as the fee transaction data.

Moreover, terminal 40 generates transaction data (also referred to as payment transaction data or first transaction data) for payment transaction based on the input for application, and transmits the generated payment transaction data to server 10A, etc. Specifically, terminal 40 generates transaction data including the same transaction date and time as the scheduled transaction date and time and the same transaction amount as the estimated transaction amount, as the payment transaction data. The fee information may include inquiry information for inquiring of payer U1, who is the user of terminal 40, whether to agree to the fee included in the fee information. That is, terminal 40 may present a user interface (UI) inquiring of payer U1 whether to agree to the amount of the fee included in the fee information. Terminal 40 determines whether input indicating agreement to the presented UI is received. In the case where input indicating agreement is received, terminal 40 generates the fee transaction data. In the case where input indicating agreement is not received, terminal 40 need not generate the fee transaction data.

Terminal 40 is, for example, a personal computer, a smartphone, a tablet, or the like.

Terminal 41 is a terminal device of a user of payee U2 to which payer U1 is to pay by transaction. Terminal 41 receives a notification indicating that payment by transaction has been made, from server 10A, etc. Having received the notification, terminal 41 may display information indicating that the payment of the payment amount included in the payment transaction data has been made by payer U1 at the transaction date and time.

Terminal 41 is, for example, a personal computer, a smartphone, a tablet, or the like.

Terminal 42 is a terminal device of business operator X. Terminal 42 receives a notification indicating that the fee has been paid by payer U1, from server 10A, etc. Having received the notification, terminal 42 may display information indicating that the payment of the fee amount included in the fee transaction data has been made by payer U1 at the transaction date and time.

Terminal 42 is, for example, a personal computer, a smartphone, a tablet, or the like.

Terminal 40 may have the function of terminal 41, and may have the function of terminal 42. Terminal 41 may have the function of terminal 40, and may have the function of terminal 42. Terminal 42 may have the function of terminal 40, and may have the function of terminal 41. Terminals 40 to 42 operate independently of one another.

A structure of server 10A or the like included in transaction management system 1 will be described in detail below.

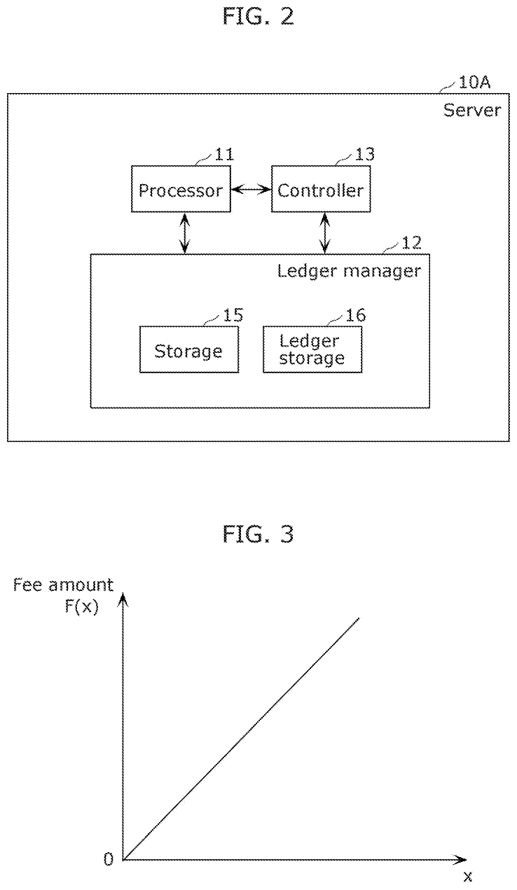

FIG. 2 is a block diagram schematically illustrating a structure of server 10A in this embodiment.

As illustrated in FIG. 2, server 10A includes processor 11, ledger manager 12, and controller 13. These functional units included in server 10A can be implemented, for example, by a central processing unit (CPU) executing a program using memory.

Processor 11 is a processor that manages various information by the distributed ledger. In the case where processor 11 receives transaction data from a device in transaction management system 1 or obtains transaction data generated by controller 13, processor 11 provides the received or obtained transaction data to ledger manager 12 to store the transaction data in the distributed ledger. The transaction data includes application transaction data, payment transaction data, and fee transaction data. Each type of transaction data will be described in detail later.

Ledger manager 12 is a processor that manages the distributed ledger. Specifically, in the case where ledger manager 12 receives transaction data, ledger manager 12 transfers the received transaction data to the plurality of other servers, and also stores the received transaction data in the distributed ledger. For example, ledger manager 12 receives payment transaction data from terminal 40, transfers the received payment transaction data to the plurality of other servers 10B and 10C different from server 10A from among the plurality of servers 10A, 10B, and 10C, and stores a first block including the payment transaction data in the distributed ledger stored in ledger storage 16. Moreover, ledger manager 12 receives fee transaction data from terminal 40, transfers the received fee transaction data to the plurality of other servers 10B and 10C, and stores a second block including the fee transaction data in the distributed ledger stored in ledger storage 16.

Thus, ledger manager 12 stores the transaction data provided from processor 11, in the distributed ledger. The distributed ledger stores transaction data from past to present. Based on the property that tampering with information recorded in the distributed ledger is difficult, the transaction data is managed so as not to be tampered with.

Ledger manager 12 includes storage 15 and ledger storage 16.

Storage 15 is a processor that stores, in ledger storage 16, new transaction data to be stored in the distributed ledger. Storage 15 stores new transaction data in ledger storage 16 in a form corresponding to the type of the distributed ledger. Storage 15 also transmits and receives communication data to and from storage 15 in each of the other servers from among server 10A, etc., to store the new transaction data in ledger storage 16 in the other server, too. For example, in the case where the distributed ledger is a blockchain, storage 15 generates a block including the new transaction data, and stores the generated block in ledger storage 16 synchronously among server 10A, etc. For example, when storing the first block in the distributed ledger, storage 15 executes a consensus algorithm together with the plurality of other servers 10B and 10C, to store the first block in the distributed ledger. For example, when storing the second block in the distributed ledger, storage 15 executes the consensus algorithm together with the plurality of other servers 10B and 10C, to store the second block in the distributed ledger.

Ledger storage 16 is a storage device that stores the distributed ledger. The distributed ledger stored in ledger storage 16 stores one or more items of transaction data, which are managed so as to resist tampering by using property such as hash values. This will be described in detail later.

The distributed ledger stored in ledger storage 16 prestores fee calculation information used to calculate a fee for performing the procedure of payment by the payer. The distributed ledger also includes code of a smart contract for calculating a fee based on application transaction data. Fee calculation will be described later.

Although an example in which the distributed ledger is a blockchain is described here, any of other types of distributed ledgers (e.g. IOTA or hash graph) may be used. The distributed ledger may or may not involve execution of a consensus algorithm (e.g. practical byzantine fault tolerance (PBFT), proof of work (PoW), or proof of stake (PoS)) when storing new data. An example of distributed ledger technology not involving execution of a consensus algorithm is Hyperledger Fabric.

Controller 13 is a processor that controls processing related to token provision. Controller 13 receives application transaction data from terminal 40, thus receiving, from terminal 40, information including the scheduled date and time of a token transaction by the payer. Controller 13 also refers to the distributed ledger stored in ledger storage 16, and calculates the amount of the fee for the scheduled transaction by payer U1 based on at least one transaction by payer U1 recorded in the distributed ledger before the scheduled transaction date and time included in the application transaction data. Controller 13 transmits fee information including the calculated fee amount to terminal 40.

For example, controller 13 calculates the fee to increase with an increase in the token balance of the payer in the distributed ledger at the scheduled transaction date and time. For example, controller 13 calculates the fee to increase with an increase in the elapsed time from the timing of the last transaction by the payer in the distributed ledger. The elapsed time is, for example, the time from the last transaction timing to the timing of receiving the application transaction data. For example, controller 13 calculates the fee to increase with a decrease in the average of the transaction volume per unit time of the transactions by the payer in the distributed ledger within a predetermined period up to the timing of receiving the application transaction data. Herein, the transaction volume in a period is, for example, the total amount paid (payment amount) by the payer in the period. The payment may be remittance, withdrawal, transfer, or the like.

All or part of the foregoing processing by controller 13 is realized by the smart contract that is implemented by executing the contract code stored in ledger storage 16. Having received the application transaction data from terminal 40, controller 13 executes the contract code included in the distributed ledger to calculate the fee. The contract code is code executed to implement the smart contract.

The fee charged to the payer for the transaction by the payer will be described below.

The fee charged to the payer is determined based on the timing of transaction application by the payer, with reference to the fee calculation information. Specifically, the fee is determined based on at least one of (i) the token balance of the payer in the distributed ledger at the timing of application, (ii) the elapsed time from the timing of the last transaction by the payer in the distributed ledger, and (iii) the average of the transaction volume per unit time of the transactions by the payer in the distributed ledger within a predetermined period up to the timing of receiving the application transaction data. The fee calculation information is, for example, a function or a table that defines fees.

FIG. 3 is an explanatory diagram illustrating an example of fee calculation information in this embodiment. The fee calculation information illustrated in FIG. 3 is an example of fee calculation information that defines fee amounts by a function.

In FIG. 3, the horizontal axis represents token balance x of the payer, and the vertical axis represents fee amount F(x) corresponding to balance x.

Function F(x), in principle, tends to increase with an increase of x. In other words, the fee amount tends to increase as the balance increases. More specifically, function F(x) is a monotonically increasing function with respect to x. Function F(x) may include a section in which the value is maintained with respect to the change of x.

Controller 13 calculates and determines the fee amount using function F(x) which is the fee calculation information illustrated in FIG. 3, in the following manner.

Various types of transaction data stored in the distributed ledger by processor 11, namely, (1) application transaction data, (2) payment transaction data, and (3) fee transaction data, will be described below.

### (1) Application Transaction Data

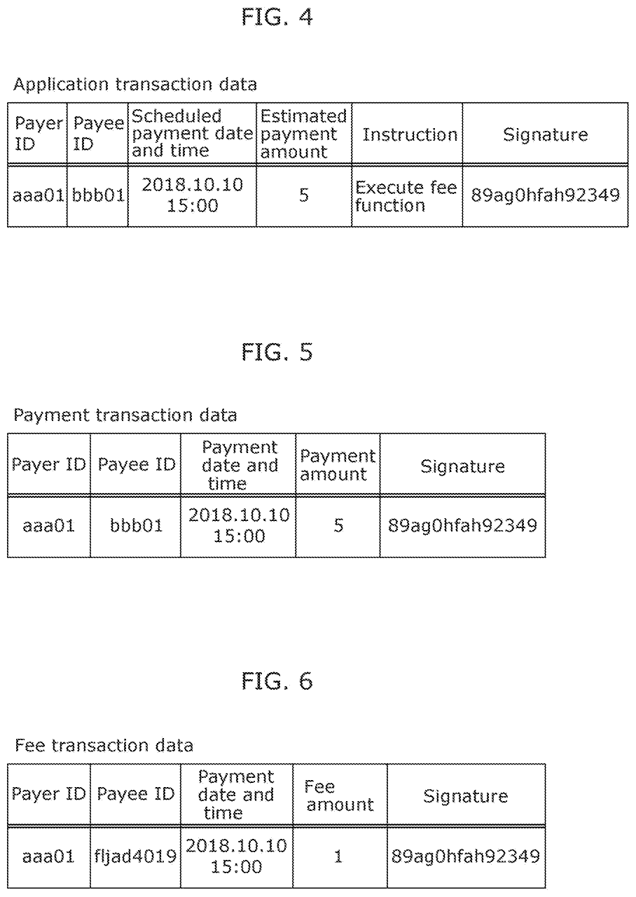

FIG. 4 is an explanatory diagram schematically illustrating application transaction data in this embodiment. The application transaction data is generated by terminal 40 of payer U1 and transmitted to server 10A, etc. when payer U1 performs a transaction.

As illustrated in FIG. 4, the application transaction data includes a payer ID, a payee ID, a scheduled payment date and time, an estimated payment amount, an instruction, and a signature.

The payer ID is an identifier for uniquely identifying the payer in the scheduled transaction (payment).

The payee ID is an identifier for uniquely identifying the payee in the scheduled transaction (payment).

The scheduled payment date and time is information indicating the scheduled timing of the transaction (payment). The scheduled payment date and time indicates the scheduled date and time of the transaction. Alternatively, only the scheduled date of the transaction may be indicated without the scheduled time.

The estimated payment amount is information indicating the estimated amount paid in the transaction. The amount is, for example, the quantity of the token.

The instruction is information for instructing server 10A to perform the process of calculating the fee for the transaction. The application transaction data may include, instead of the instruction, information indicating that the transaction data is application transaction data including information indicating that the transaction is scheduled. In this case, when server 10A or the like receives the application transaction data, server 10A or the like may calculate the fee upon detecting that the received transaction data includes information indicating that the transaction data is application transaction data.

The signature is an electronic signature by the device or person that generates the application transaction data.

The application transaction data illustrated in FIG. 4 is application transaction data indicating that the payer whose payer ID is “aaa001” is scheduled to pay to the payee whose payee ID is “bbb01”. In the scheduled transaction, the estimated payment amount is “5” token, and the scheduled payment date and time is “2018.10.10 15:00”. The signature is an electronic signature of the payer.

### (2) Payment Transaction Data

FIG. 5 is an explanatory diagram schematically illustrating payment transaction data in this embodiment. The payment transaction data is generated by terminal 40 of payer U1 and transmitted to server 10A, etc. when payer U1 performs a transaction.

As illustrated in FIG. 5, the payment transaction data includes a payer ID, a payee ID, a payment date and time, a payment amount, and a signature.

The payer ID is an identifier for uniquely identifying the payer in the transaction (payment).

The payee ID is an identifier for uniquely identifying the payee in the transaction (payment).

The payment date and time is information indicating the timing of the transaction (payment). The payment date and time indicates the date and time of the transaction. Alternatively, only the date of the transaction may be indicated without the time of the transaction.

The payment amount is information indicating the amount paid in the transaction. The amount is, for example, the quantity of the token.

The signature is an electronic signature by the device or person that generates the payment transaction data.

The payment transaction data illustrated in FIG. 5 is payment transaction data indicating the transaction in which the payer whose payer ID is “aaa001” pays to the payee whose payee ID is “bbb01”. In the transaction, the payment amount is “5” token, and the payment date and time is “2018.10.10 15:00”. The signature is an electronic signature of the payer.

### (3) Fee Transaction Data

FIG. 6 is an explanatory diagram schematically illustrating fee transaction data in this embodiment. The fee transaction data is generated by terminal 40 of payer U1 and transmitted to server 10A, etc. when payer U1 performs a transaction.

As illustrated in FIG. 6, the fee transaction data includes a payer ID, a payee ID, a payment date and time, a fee amount, and a signature.

The payer ID is an identifier for uniquely identifying the payer in the payment of the fee for the transaction.

The payee ID is an identifier for uniquely identifying the payee of the fee for the transaction.

The payment date and time is information indicating the timing of the payment of the fee for the transaction. The payment date and time indicates the date and time of the payment of the fee. Alternatively, only the date of the payment of the fee may be indicated without the time of the payment of the fee.

The fee amount is information indicating the amount of the fee for the transaction. The amount is, for example, the quantity of the token.

The signature is an electronic signature by the device or person that generates the fee transaction data.

The fee transaction data illustrated in FIG. 6 is fee transaction data indicating that the payer whose payer ID is “aaa001” pays the fee to the payee whose payee ID is “fljad4019”. In the payment of the fee, the payment amount is “1” token, and the payment date and time is “2018.10.10 15:00”. The signature is an electronic signature of the payer.

A specific example of processing in transaction management system 1 will be described below.

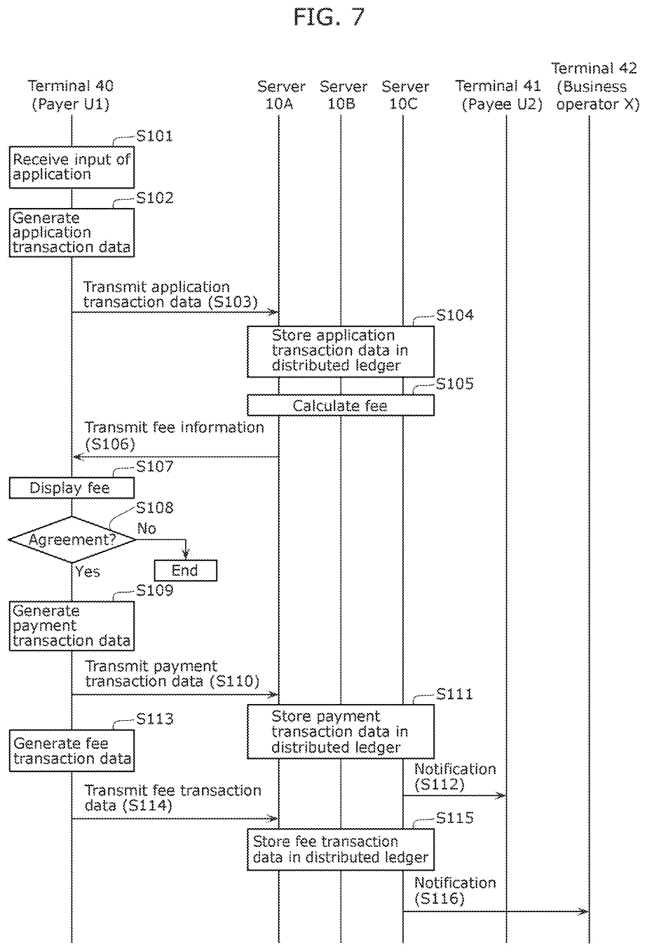

FIG. 7 is a flowchart illustrating an example of processing in transaction management system 1 in this embodiment.

Terminal 40 of payer U1 receives input indicating a scheduled transaction date and time and input indicating an estimated transaction amount from payer U1 (S101).

Terminal 40 generates application transaction data including the scheduled transaction date and time and the estimated transaction amount, based on the received input (S102).

Terminal 40 transmits the generated application transaction data to server 10A or the like (S103). Here, terminal 40 may transmit the generated application transaction data to one server or a plurality of servers from among server 10A, etc.

Server 10A or the like receives the application transaction data transmitted from terminal 40, and stores the application transaction data in the distributed ledger (S104).

Server 10A or the like calculates the amount of the fee required for the procedure of payment by payer U1 of terminal 40 from which the application transaction data is transmitted (S105).

Server 10A or the like transmits fee information including the calculated amount of the fee to terminal 40 of payer U1 (S106). Here, not all of the plurality of servers constituting server 10A, etc. need to transmit the fee information to terminal 40. For example, the server that has calculated the amount of the fee may transmit the fee information to terminal 40, and transmit, to the other servers, completion information indicating that the amount of the fee has been calculated. In the case where the other servers have not transmitted the fee information to terminal 40 upon receiving the completion information, the other servers may not transmit the fee information to terminal 40.

Having received the fee information transmitted from server 10A or the like, terminal 40 displays the amount of the fee included in the fee information (S107). Here, terminal 40 may present a user interface (UI) for inquiring of payer U1 whether to agree to the amount of the fee included in the fee information.

FIG. 8 is a diagram illustrating an example of UI 50 displayed by display 60 in terminal 40.

UI 50 includes fee amount 51, agreement button 52 for receiving input indicating agreement to pay the fee, and disagreement button 53 for receiving input indicating disagreement to pay the fee.

Terminal 40 determines whether input indicating agreement to the presented UI is received (S108).

In the case where input indicating agreement is received (S108: Yes), for example, in the case where input to agreement button 52 in UI 50 is received, terminal 40 generates payment transaction data including the same transaction date and time as the scheduled transaction date and time and the same transaction amount as the estimated transaction amount, based on the input received in Step S101 (S109). In the case where input indicating disagreement is received, for example, in the case where input to disagreement button 53 in UI 50 is received, or in the case where input indicating agreement is not received for a predetermined period (S108: No), terminal 40 ends the processing related to the transaction. In this case, terminal 40 may transmit end information indicating the end of the processing, to server 10A or the like. Having received the end information, server 10A or the like ends the processing related to the transaction. Server 10A or the like may end the processing related to the transaction in the case where information (for example, payment transaction data or fee transaction data) is not received from terminal 40 for a predetermined period after the transmission of the fee information, instead of in the case where the end information is received.

After Step S109, terminal 40 transmits the generated payment transaction data to server 10A or the like (S110). Here, terminal 40 may transmit the generated payment transaction data to one server or a plurality of servers from among server 10A, etc.

Server 10A or the like receives the payment transaction data transmitted from terminal 40, and stores the payment transaction data in the distributed ledger (S111).

Server 10A or the like notifies terminal 41 of payee U2 that the payment of the payment amount included in the payment transaction data has been made by payer U1 at the transaction date and time (S112).

After Step S109, terminal 40 generates fee transaction data including the amount of the fee, based on the fee information (S113).

Terminal 40 transmits the generated fee transaction data to server 10A or the like (S114). Here, terminal 40 may transmit the generated fee transaction data to one server or a plurality of servers from among server 10A, etc.

Server 10A or the like receives the fee transaction data transmitted from terminal 40, and stores the fee transaction data in the distributed ledger (S115).

Server 10A or the like notifies terminal 42 of business operator X that the payment of the fee amount included in the fee transaction data has been made by payer U1 at the transaction date and time (S116).

Step S109 may be performed after Step S113 or simultaneously with Step S113. Step S110 may be performed after Step S114 or simultaneously with Step S114. Step S111 may be performed after Step S115 or simultaneously with Step S115. Step S112 may be performed after Step S116 or simultaneously with Step S116.

As described above, with the control method according to this embodiment, the fee is calculated based on one or more transactions by payer U1 recorded in the distributed ledger before the scheduled date and time included in the received application transaction data, and payer U1 is requested to pay the fee. Thus, for example, by adjusting the calculated amount of the fee, the timings of occurrence of transactions can be controlled so that the processing of the plurality of servers for managing token transactions will not be concentrated in a specific period. Consequently, the processing of the plurality of servers can be stabilized, and power consumed without transaction-related processing being performed can be saved.

Moreover, the fee can be calculated promptly and safely without involving any other person or system. Thus, the power consumption of the plurality of servers that manage token transactions can be reduced.

Moreover, the distributed ledger is stored as a result of the execution of the consensus algorithm. The execution of the consensus algorithm can thus facilitate appropriate management of token transactions.

In the fee calculation, the fee is calculated to increase with an increase in the token balance of payer U1 in the distributed ledger. In the fee calculation, the fee is calculated to increase with an increase in the elapsed time from the timing of the last transaction by payer U1 in the distributed ledger. In the fee calculation, the fee is calculated to increase with a decrease in the average of the transaction volume per unit time of the transactions by the payer in the distributed ledger within a predetermined period up to the current time. Thus, a higher amount of fee can be requested when payer U1 uses the token less. In this way, payer U1 can be encouraged to use the token early. The timings of occurrence of transactions can thus be controlled.

The fee information is information for displaying the fee on display 60 in terminal 40. By displaying the fee on display 60 in terminal 40, payer U1 can be encouraged to use the token early. The timings of occurrence of transactions can thus be controlled.

The fee information includes inquiry information for inquiring of payer U1 whether to agree to the fee included in the fee information. In this way, whether to agree to the fee can be inquired of payer U1 via terminal 40. Hence, the timing of payer U1 using the token can be adjusted. For example, the timing of using the token can be made earlier when the amount of the fee is larger. The timings of occurrence of transactions can thus be controlled.

### (Variation 1)

In the foregoing embodiment, the token may include a plurality of types of tokens. That is, transaction management system 1 may manage transactions of a plurality of types of tokens. In this case, the distributed ledger of each of server 10A, etc. includes a plurality of different sub-distributed ledgers for the respective different types of tokens. For example, in the case where there are two types of tokens: token A and token B, the distributed ledger includes sub-distributed ledger A indicating transactions of token A and sub-distributed ledger B indicating transactions of token B.

In the fee calculation (S105), controller 13 in server 10A or the like calculates a plurality of fees for the respective different types of tokens, based on the transactions by payer U1 recorded in the plurality of sub-distributed ledgers before the scheduled date and time included in the application information. For example, controller 13 calculates fee A for the transaction of token A, based on the transactions of token A by payer U1 recorded in sub-distributed ledger A before the scheduled date and time included in the application information. Controller 13 also calculates fee B for the transaction of token B, based on the transactions of token B by payer U1 recorded in sub-distributed ledger B before the scheduled date and time included in the application information.

In the fee calculation, in the case where the circulation of token A is high and the circulation of token B is low in comparison with token A, controller 13 may set the fee for the transaction of token B to be lower than the fee for the transaction of token A in order to increase the circulation of token B. Herein, “circulation” may denote, for example, the average of the transaction volume of a plurality of users per unit time within a predetermined period up to the current time. The transaction volume of the plurality of users may be the total transaction volume of all users using a specific type of token. Herein, “average” may denote not only the average per unit time but also the average per user. Setting the fee for the transaction of token B to be lower than the fee for the transaction of token A is to calculate the value of token B to be lower than the value of token A when converted in a common value used for comparing the value of token A and the value of token B. In this case, for example, in the fee calculation, the relation indicating the fee calculation information for calculating the fee for token B may be adjusted so that the fee amount converted in the common value will be lower at each balance, each elapsed time, or each average than the relation indicating the fee calculation information for calculating the fee for token A, and the fee for token A and fee for token B may be calculated using the adjusted two relations. For example, in the adjustment, the fee amount in the relation of token B may be multiplied by a coefficient less than 1 to make the relation of token B lower than the relation of token A, or the fee amount in the relation of token A may be multiplied by a coefficient greater than 1 to make the relation of token B lower than the relation of token A. For example, in the adjustment, a predetermined fee amount may be subtracted from the fee amount in the relation of token B (i.e. the fee amount in the relation of token B is offset in the negative direction) to make the relation of token B lower than the relation of token A, or a predetermined fee amount may be added to the fee amount in the relation of token A (i.e. the fee amount in the relation of token A is offset in the positive direction) to make the relation of token B lower than the relation of token A.

In the fee transmission (S106), controller 13 transmits information including the calculated plurality of fees, i.e. fee A and fee B, to terminal 40 as the fee information. By calculating the fee for each of the plurality of types of tokens in this way, the transaction volume can be adjusted for each type of token.

Terminal 40, having received the fee information transmitted from server 10A or the like, displays the amount of the fee included in the fee information for each of the different types of tokens on display 60 in terminal 40 (S107). That is, the fee information is information for displaying the fee for each of the different types of tokens on display 60 in terminal 40. By displaying the fee for each type of token on display 60 in terminal 40, payer U1 can be encouraged to use each type of token early. The timings of occurrence of transactions can thus be controlled for each type of token.

FIG. 9 is a diagram illustrating an example of UI 50A displayed by display 60 in terminal 40.

UI 50A displays fee A for the transaction of token A. UI 50A includes amount 51A of fee A, agreement button 52A for receiving input indicating agreement to pay fee A, disagreement button 53A for receiving input indicating disagreement to pay fee A, and switch button 54A for switching the display to UI 50B displaying fee B.

In the case where input indicating agreement to fee A for token A is received, for example, in the case where input to agreement button 52A in UI 50A is received, terminal 40 generates payment transaction data including the same transaction date and time as the scheduled transaction date and time and the same transaction amount as the estimated transaction amount, based on the input received in Step S101. The generated payment transaction data further includes information indicating using token A for the transaction. In the case where input indicating disagreement is received, for example, in the case where input to disagreement button 53A in UI 50A is received, or in the case where input indicating agreement is not received for a predetermined period, terminal 40 ends the processing related to the transaction or switches the display to UI 50B displaying fee B.

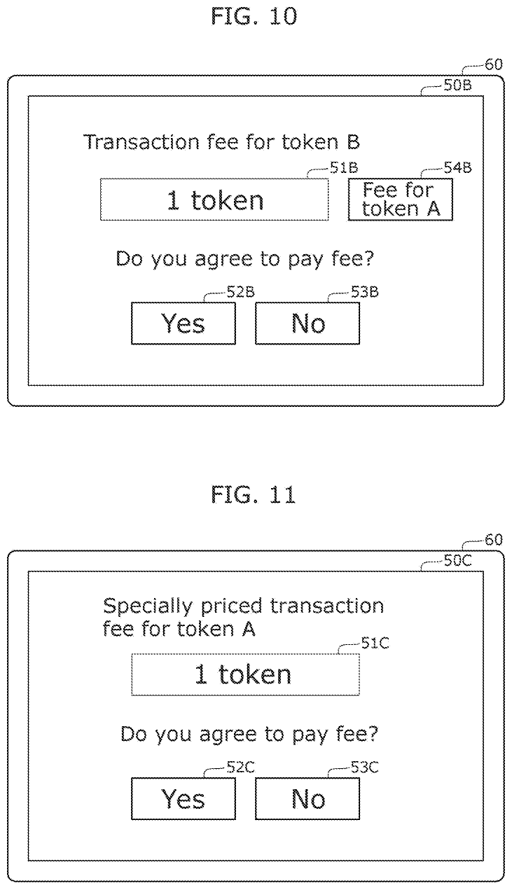

FIG. 10 is a diagram illustrating an example of UI 50B displayed by display 60 in terminal 40.

UI 50B displays fee B for the transaction of token B. UI 50B includes amount 51B of fee B, agreement button 52B for receiving input indicating agreement to pay fee B, disagreement button 53B for receiving input indicating disagreement to pay fee B, and switch button 54B for switching the display to UI 50A displaying fee A.

In the case where input indicating agreement to fee B for token B is received, for example, in the case where input to agreement button 52B in UI 50B is received, terminal 40 generates payment transaction data including the same transaction date and time as the scheduled transaction date and time and the same transaction amount as the estimated transaction amount, based on the input received in Step S101. The generated payment transaction data further includes information indicating using token B for the transaction. In the case where input indicating disagreement is received, for example, in the case where input to disagreement button 53B in UI 50B is received, or in the case where input indicating agreement is not received for a predetermined period, terminal 40 ends the processing related to the transaction or switches the display to UI 50A displaying fee A.

In the case of ending the processing, terminal 40 may transmit end information indicating the end of the processing, to server 10A or the like. Having received the end information, server 10A or the like ends the processing related to the transaction. Server 10A or the like may end the processing related to the transaction not only in the case where the end information is received but also in the case where information (for example, payment transaction data or fee transaction data) is not received from terminal 40 for a predetermined period after the transmission of the fee information.

FIG. 11 is a diagram illustrating an example of UI 50C displayed by display 60 in terminal 40. UI 50C is a UI in an example different from UI 50A and UI 50B.

UI 50C displays fee A for the transaction of token A with a specially priced (i.e. cheaper) fee as compared with token B. UI 50C includes amount 51C of fee C, agreement button 52C for receiving input indicating agreement to pay fee C, and disagreement button 53C for receiving input indicating disagreement to pay fee C. UI 50C may further include a switch button for switching the display to a UI displaying fee B.

Each UI may further include a message indicating the reason for calculating the presented fee. For example, the message may indicate that the presented fee is calculated because the token balance of the payer in the distributed ledger at the scheduled transaction date and time is a predetermined balance. In this case, the message may indicate that a lower token balance contributes to a cheaper fee. For example, the message may indicate that the presented fee is calculated because the elapsed time from the timing of the last transaction by the payer in the distributed ledger is a predetermined elapsed time. In this case, the message may indicate that a shorter elapsed time contributes to a cheaper fee. For example, the message may indicate that the presented fee is calculated because the average of the transaction volume per unit time of the transactions by the payer in the distributed ledger within a predetermined period up to the timing of receiving the application transaction data is a predetermined average value. In this case, the message may indicate that a larger average value contributes to a cheaper fee.

### (Variation 2)

In this variation, another structure of the transaction management system in the foregoing embodiment will be described below.

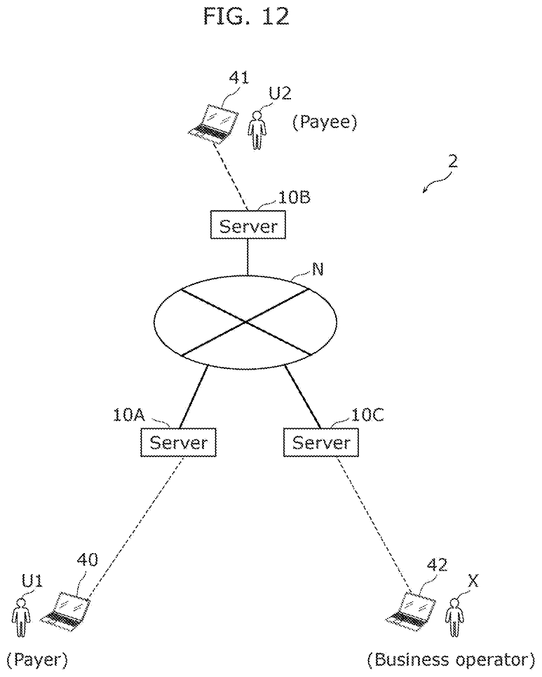

FIG. 12 is a block diagram schematically illustrating a structure of transaction management system 2 in this variation.

As illustrated in FIG. 12, transaction management system 2 includes servers 10A, 10B, and 10C and terminals 40, 41, and 42. The devices included in transaction management system 2 are communicably connected to one another via network N. Network N may be any communication line or network. Examples include the Internet and a mobile phone carrier network.

In particular, in transaction management system 2, servers 10A, 10B, and 10C are connected to one another via network N. Moreover, terminal 40 is connected to server 10A, terminal 41 is connected to server 10B, and terminal 42 is connected to server 10C.

Such a structure is usable, for example, in the case where a plurality of groups run transaction management system 2 and the servers managed by the groups are connected via network N. For example, server 10A and terminal 40 belongs to group A, server 10B and terminal 41 belongs to group B, and server 10C and terminal 42 belongs to group C.

The operations of server 10A, etc. and terminal 40, etc. are the same as those in the foregoing embodiment, and accordingly their description is omitted.

### (Variation 3)

In this variation, another structure of the transaction management system in the foregoing embodiment will be described below.

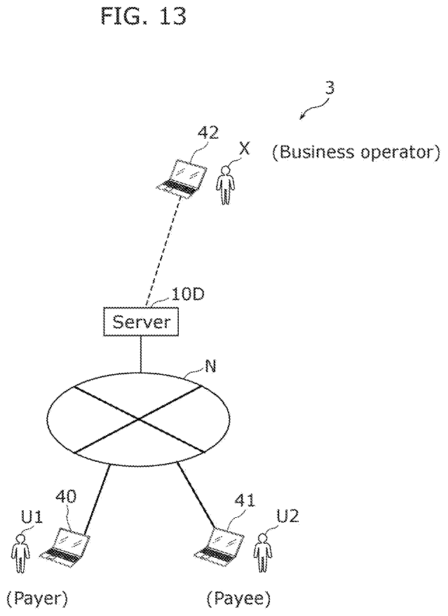

FIG. 13 is a block diagram schematically illustrating a structure of transaction management system 3 in this variation.

As illustrated in FIG. 13, transaction management system 3 includes server 10D and terminals 40, 41, and 42. The devices included in transaction management system 3 are communicably connected to one another via network N. Network N may be any communication line or network. Examples include the Internet and a mobile phone carrier network.

In particular, in transaction management system 3, server 10D and terminals 40 and 41 are connected to one another via network N. Moreover, terminal 42 is connected to server 10D. In this case, server 10D and terminals 40 and 41 each operate as server 10A or the like in the foregoing embodiment.

Such a structure is usable, for example, in the case where one or more groups and one or more individuals run transaction management system 3 and the respective one or more servers and one or more terminals managed by the one or more groups and one or more individuals are connected via network N. For example, server 10D and terminal 42 belong to group D, and group D and payer U1 and payee U2 as individuals run transaction management system 3.

The operations of server 10D and terminal 40, etc. are the same as those in the foregoing embodiment, and accordingly their description is omitted.

### (Variation 4)

Variation 4 of the embodiment will be described below.

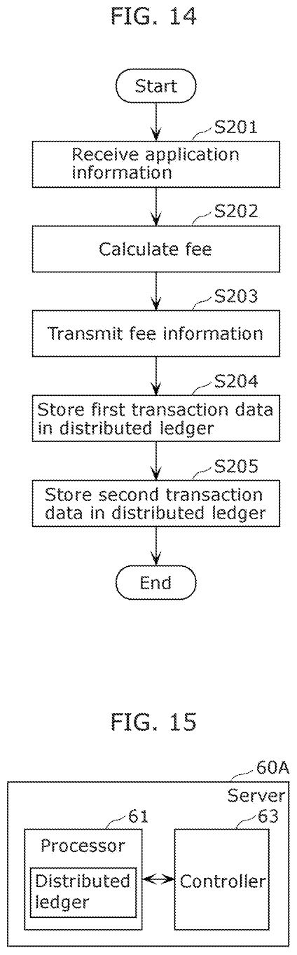

FIG. 14 is a flowchart illustrating processing in a server in this variation.

As illustrated in FIG. 14, server 10A or the like receives, from terminal 40 operated by payer U1 as a first user, application information including a scheduled date and time of a transaction by payer U1 (S201).

Each of servers 10A to 10C refers to a first distributed ledger managed by the server, and calculates a fee based on the transactions by payer U1 recorded in the first distributed ledger before the scheduled date and time included in the received application information (S202).

Each of servers 10A to 10C transmits fee information including the calculated fee to terminal 40 (S203).

Each of servers 10A to 10C receives, from terminal 40, first transaction data including a first token quantity indicating the quantity of the token for the transaction corresponding to the scheduled transaction, transfers the received first transaction data to a plurality of other servers different from the server (the server that performs the process in Step S204) from among the plurality of servers 10A to 10C, and stores a first block including the first transaction data in the first distributed ledger (S204).

Each of servers 10A to 10C receives, from terminal 40, second transaction data including a second token quantity indicating the quantity of the token for the fee, transfers the received second transaction data to the plurality of other servers, and stores a second block including the second transaction data in the first distributed ledger (S205).

Thus, the timings of occurrence of transactions can be controlled so that the processing of the plurality of servers for managing token transactions will not be concentrated in a specific period. Consequently, the processing of the plurality of servers can be stabilized, and power consumed without transaction-related processing being performed can be saved.

FIG. 15 is a block diagram schematically illustrating a structure of a server in Variation 4 of the embodiment.

As illustrated in FIG. 15, in a transaction management system including a plurality of servers that each have a distributed ledger, one server 60A from among the plurality of servers includes processor 61 and controller 63.

Processor 61 receives, from terminal 40 operated by payer U1 as a first user, application information including a scheduled date and time of a transaction by payer U1.

Controller 63 refers to a first distributed ledger managed by the server, and calculates a fee based on the transactions by payer U1 recorded in the first distributed ledger before the scheduled date and time included in the received application information. Controller 63 transmits fee information including the calculated fee to terminal 40.

Further, processor 61 receives, from terminal 40, first transaction data including a first token quantity indicating the quantity of the token for the transaction corresponding to the scheduled transaction, transfers the received first transaction data to a plurality of other servers different from the server (the server including processor 61) from among the plurality of servers 10A to 10C, and stores a first block including the first transaction data in the first distributed ledger. Processor 61 also receives, from terminal 40, second transaction data including a second token quantity indicating the quantity of the token for the fee, transfers the received second transaction data to the plurality of other servers, and stores a second block including the second transaction data in the first distributed ledger.

Thus, the timings of occurrence of transactions can be controlled so that the processing of the plurality of servers for managing token transactions will not be concentrated in a specific period. Consequently, the processing of the plurality of servers can be stabilized, and power consumed without transaction-related processing being performed can be saved.

### SUPPLEMENTAL REMARKS

A blockchain in the foregoing embodiment or variations will be described below.

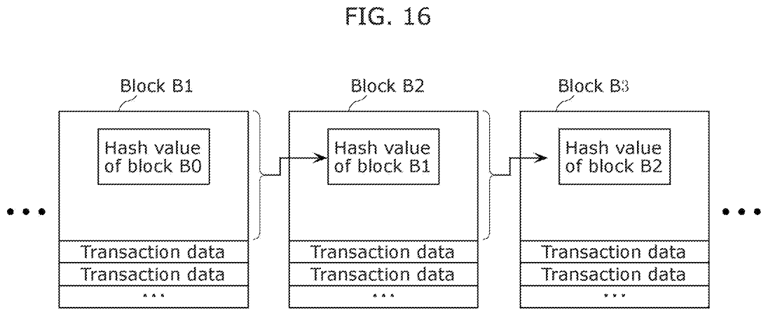

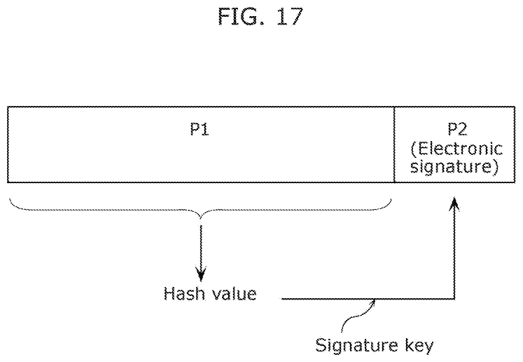

FIG. 16 is an explanatory diagram illustrating a data structure of a blockchain.

The blockchain is formed by connecting blocks as recording units in a chain. Each block has a plurality of items of transaction data and a hash value of the immediately previous block. Specifically, block B2 includes a hash value of block B1 preceding block B2. A hash value calculated from a plurality of items of transaction data and the hash value of block B1 included in block B2 is included in block B3 as a hash value of block B2. By connecting blocks in a chain where each block includes information of the previous block as a hash value in this way, tampering with recorded transaction data can be effectively prevented.

If past transaction data is changed, the hash value of the block will end up being different from the value before the change. To disguise the tampered block as proper, all subsequent blocks need to be recreated. Such operation is practically very difficult. This property is used to ensure the difficulty of tampering with blockchains.

FIG. 17 is an explanatory diagram illustrating a data structure of transaction data.

The transaction data illustrated in FIG. 17 includes transaction body P1 and electronic signature P2. Transaction body P1 is a data body included in the transaction data. Electronic signature P2 is generated by signing a hash value of transaction body P1 using a signature key of the generator of the transaction data, i.e. by encrypting the hash value using a private key of the generator.

Since the transaction data includes electronic signature P2, tampering is substantially impossible. Tampering with the transaction body is thus prevented.

Each of the structural elements in the foregoing embodiment may be configured in the form of an exclusive hardware product, or may be realized by executing a software program suitable for the structural element. Each of the structural elements may be realized by means of a program executing unit, such as a CPU and a processor, reading and executing the software program recorded on a recording medium such as a hard disk or semiconductor memory. For example, software for realizing the content management system, etc. according to the foregoing embodiment is the following program.

The program causes a computer to execute a control method executed by a server from among a plurality of servers that manage transactions of a token using a plurality of distributed ledgers and each manage one or more distributed ledgers from among the plurality of distributed ledgers, the control method including: receiving application information including a scheduled date and time of a transaction by a first user, from a terminal operated by the first user; calculating, with reference to a first distributed ledger managed by the server, a fee based on a transaction by the first user recorded in the first distributed ledger before the scheduled date and time included in the application information received; transmitting fee information including the fee calculated, to the terminal; receiving, from the terminal, first transaction data including a first token quantity indicating a quantity of the token for the transaction scheduled, transferring the first transaction data received to a plurality of other servers different from the server from among the plurality of servers, and storing a first block including the first transaction data in the first distributed ledger; and receiving, from the terminal, second transaction data including a second token quantity indicating a quantity of the token for the fee, transferring the second transaction data received to the plurality of other servers, and storing a second block including the second transaction data in the first distributed ledger.

While a control method, etc. according to one or more aspects have been described above by way of embodiments, the present invention is not limited to such embodiments. Other modifications obtained by applying various changes conceivable by a person skilled in the art to the embodiments and any combinations of the structural elements in different embodiments without departing from the scope of the present invention are also included in the scope of one or more aspects.

### INDUSTRIAL APPLICABILITY

The presently disclosed technique can be used, for example, in a transaction management system that manages token transactions.

1. A control method executed by a server from among a plurality of servers that manage transactions of a token using a plurality of distributed ledgers and each manage one or more distributed ledgers from among the plurality of distributed ledgers, the control method comprising:
receiving application information including a scheduled date and time of a transaction by a first user, from a terminal operated by the first user;
calculating, with reference to a first distributed ledger managed by the server, a fee based on a transaction by the first user recorded in the first distributed ledger before the scheduled date and time included in the application information received;
transmitting fee information including the fee calculated, to the terminal;
receiving, from the terminal, first transaction data including a first token quantity indicating a quantity of the token for the transaction scheduled, transferring the first transaction data received to a plurality of other servers different from the server from among the plurality of servers, and storing a first block including the first transaction data in the first distributed ledger; and
receiving, from the terminal, second transaction data including a second token quantity indicating a quantity of the token for the fee, transferring the second transaction data received to the plurality of other servers, and storing a second block including the second transaction data in the first distributed ledger.

2. The control method according to claim 1,
wherein the application information is third transaction data including the scheduled date and time,
the plurality of distributed ledgers each include contract code for calculating the fee based on the third transaction data, and
the calculating includes calculating the fee by executing the contract code included in the first distributed ledger, when the third transaction data is received.

3. The control method according to claim 1,
wherein the storing of the first block includes executing a consensus algorithm together with the plurality of other servers and storing the first block in the first distributed ledger, and
the storing of the second block includes executing the consensus algorithm together with the plurality of other servers and storing the second block in the first distributed ledger.

4. The control method according to claim 1,
wherein the calculating includes calculating the fee to increase with an increase in a balance of the token of the first user in the first distributed ledger.

5. The control method according to claim 1,
wherein the calculating includes calculating the fee to increase with an increase in an elapsed time from a timing of a last transaction by the first user in the first distributed ledger.

6. The control method according to claim 1,
wherein the calculating includes calculating the fee to increase with a decrease in an average of a transaction volume per unit time of transactions by the first user in the first distributed ledger within a predetermined period up to a current time.

7. The control method according to claim 1,
wherein the fee information is information for displaying the fee on a display of the terminal.

8. The control method according to claim 1,
wherein the token includes a plurality of types of tokens,
the first distributed ledger includes a plurality of different sub-distributed ledgers each for a different one of the plurality of types of tokens,
the calculating includes calculating a plurality of fees each for the different one of the plurality of types of tokens, based on a transaction by the first user recorded in the plurality of different sub-distributed ledgers before the scheduled date and time included in the application information, and
the transmitting includes transmitting, as the fee information, information including the plurality of fees calculated, to the terminal.

9. The control method according to claim 8,
wherein the fee information is information for displaying each of the plurality of fees for the different one of the plurality of types of tokens, on a display of the terminal.

10. The control method according to claim 1,
wherein the fee information includes inquiry information for inquiring of the first user whether to agree to the fee included in the fee information.

11. A server from among a plurality of servers that manage transactions of a token using a plurality of distributed ledgers and each manage one or more distributed ledgers from among the plurality of distributed ledgers, the server comprising:
a manager that manages a first distributed ledger from among the plurality of distributed ledgers;
a receiver that receives, from a terminal operated by a first user, application information including a scheduled date and time of a transaction by the first user, first transaction data including a first token quantity indicating a quantity of the token for the transaction scheduled, and second transaction data including a second token quantity indicating a quantity of the token for a fee;
a calculator that calculates, with reference to the first distributed ledger in the manager, the fee based on a transaction by the first user recorded in the first distributed ledger before the scheduled date and time included in the application information received; and
a transmitter that transmits fee information including the fee calculated, to the terminal,
wherein when the receiver receives the first transaction data, the transmitter transfers the first transaction data received to a plurality of other servers different from the server from among the plurality of servers, and the manager records a first block including the first transaction data in the first distributed ledger, and
when the receiver receives the second transaction data, the transmitter transfers the second transaction data received to the plurality of other servers, and the manager records a second block including the second transaction data in the first distributed ledger.

12. A non-transitory computer-readable recording medium having a program recorded thereon for causing a computer to execute the control method according to claim 1.
